(19) United States
(12) Patent Application Publication
(10) Pub. No.: US 2024/0213634 A1
(43) Pub. Date: Jun. 27, 2024

(54) POWER STORAGE CELL

(71) Applicant: TOYOTA JIDOSHA KABUSHIKI KAISHA, Toyota-shi (JP)

(72) Inventors: Atsushi SUGIHARA, Toyota-shi (JP); Seigo FUJISHIMA, Miyoshi-shi (JP); Takeru HARA, Toyota-shi (JP); Jun IZUMI, Toyota-shi (JP); Tsuyoshi KANEKO, Nisshin-shi (JP)

(73) Assignee: TOYOTA JIDOSHA KABUSHIKI KAISHA, Toyota-shi (JP)

(21) Appl. No.: 18/503,469

(22) Filed: Nov. 7, 2023

(30) Foreign Application Priority Data
Dec. 22, 2022 (JP) 2022-205532

(51) Int. Cl. H01M 50/583; H01M 10/04; H01M 50/103; H01M 50/566

(52) U.S. Cl. CPC H01M 50/583; H01M 10/0431; H01M 50/103; H01M 50/566

(57) ABSTRACT

A power storage cell comprises a cell case and an electrode assembly. The cell case accommodates the electrode assembly. The cell case includes an electrode terminal. An electric current path is formed inside the cell case. The electric current path electrically connects the electrode assembly with the electrode terminal. The electric current path includes a fuse portion. Tensile stress is applied to the fuse portion in a direction separating the fuse portion.

### CROSS REFERENCE TO RELATED APPLICATIONS

This nonprovisional application is based on Japanese Patent Application No. 2022-205532 filed on Dec. 22, 2022, with the Japan Patent Office, the entire contents of which are hereby incorporated by reference.

### BACKGROUND OF THE DISCLOSURE

### Field

The present disclosure relates to a power storage cell.

### Description of the Background Art

Japanese Patent Laying-Open No. 2015-103521 discloses a secondary battery that comprises a fuse portion.

### SUMMARY OF THE DISCLOSURE

Providing a fuse portion inside a power storage cell (a secondary battery) has been suggested. At the time when an overcurrent occurs inside the power storage cell, the fuse portion can be blown and thereby an electric current path can be interrupted. However, after the fuse portion is blown, there is a chance that the power storage cell can undergo vibration and the like. There is also a chance that due to the vibration and the like, tips of the blown fuse portion can be reconnected to each other.

An object of the present disclosure is to provide a fuse portion that is less likely to become reconnected.

Hereinafter, the technical configuration and effects of the present disclosure will be described. It should be noted that the action mechanism according to the present specification includes presumption. The action mechanism does not limit the technical scope of the present disclosure.

1. A power storage cell comprises a cell case and an electrode assembly. The cell case accommodates the electrode assembly. The cell case includes an electrode terminal. An electric current path is formed inside the cell case. The electric current path electrically connects the electrode assembly with the electrode terminal. The electric current path includes a fuse portion. Tensile stress is applied to the fuse portion in a direction separating the fuse portion.

The fuse portion can be blown by an overcurrent. Tensile stress is applied in a direction separating the fuse portion. At the time when the fuse portion is blown, the tensile stress is capable of acting to separate the blown tips from each other. Thus, a fuse portion that is less likely to become reconnected may be provided.

2. In the power storage cell according to “1” above, the tensile stress may be generated by a self-weight of the electrode assembly, for example.

3. In the power storage cell according to “1” or “2” above, the electric current path may further include a welded portion, for example. The tensile stress may remain in the welded portion.

4. In the power storage cell according to any one of “1” to “3” above, the electric current path may further include a flexurally-deformed portion, for example. The tensile stress may be generated by springback of the flexurally-deformed portion.

5. In the power storage cell according to any one of “1” to “4” above, the tensile stress may be applied parallel to a current flow direction, for example.

6. In the power storage cell according to any one of “1” to “5” above, the tensile stress may be applied vertically to a current flow direction, for example.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic perspective view of a first power storage cell according to the present embodiment.

FIG. 2 is an exploded perspective view of the first power storage cell according to the present embodiment.

FIG. 3 is a schematic cross-sectional view of the first power storage cell according to the present embodiment.

FIG. 4 is a first conceptual view of a fuse portion according to the present embodiment.

FIG. 5 is a second conceptual view of the fuse portion according to the present embodiment.

FIG. 6 is a third conceptual view of the fuse portion according to the present embodiment.

FIG. 7 is a fourth conceptual view of the fuse portion according to the present embodiment.

FIG. 8 is a fifth conceptual view of the fuse portion according to the present embodiment.

FIG. 9 is a sixth conceptual view of the fuse portion according to the present embodiment.

FIG. 10 is a schematic perspective view of a second power storage cell according to the present embodiment.

FIG. 11 is an exploded perspective view of the second power storage cell according to the present embodiment.

### DESCRIPTION OF THE PREFERRED EMBODIMENTS

### 1. Definitions of Terms, etc.

Expressions such as “comprise”, “include”, and “have”, and other similar expressions (such as “be composed of”, for example) are open-ended expressions. In an open-ended expression, in addition to an essential component, an additional component may or may not be further included. The expression “consist of” is a closed-end expression. However, even when a closed-end expression is used, impurities present under ordinary circumstances as well as an additional element irrelevant to the technique according to the present disclosure are not excluded. The expression “consist essentially of” is a semiclosed-end expression. A semiclosed-end expression tolerates addition of an element that does not substantially affect the fundamental, novel features of the technique according to the present disclosure.

In the present embodiment, any geometric term (such as “parallel”, “vertical”, and “orthogonal”, for example) should not be interpreted solely in its exact meaning. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. The dimensional relationship (in length, width, thickness, and the like) in each figure may have been changed for the purpose of assisting understanding for the readers. Further, a part of a given configuration may have been omitted. In the drawings referenced below, members whose functions are the same as or equivalent to each other are denoted by the same numeral.

For instance, “at least one of A and B” includes “A or B” and “A and B”. “At least one of A and B” may also be expressed as “A and/or B”.

“Electrode” collectively refers to a positive electrode and a negative electrode. An electrode may refer to at least one of a positive electrode and a negative electrode. For instance, an electrode terminal may refer to at least one of a positive electrode terminal and a negative electrode terminal.

### 2. First Power Storage Cell

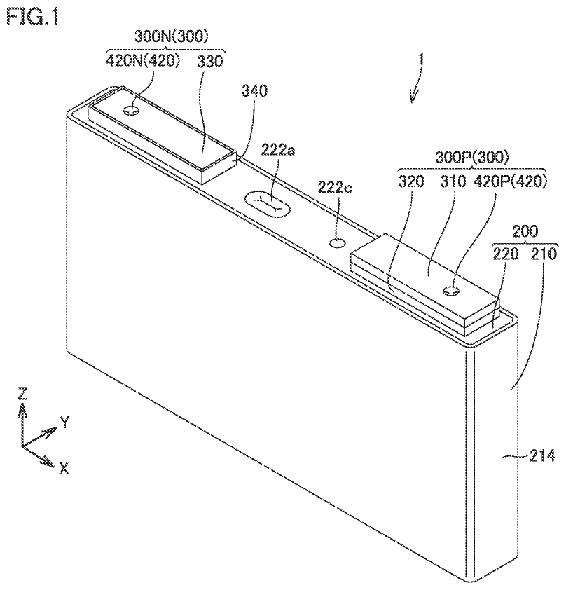

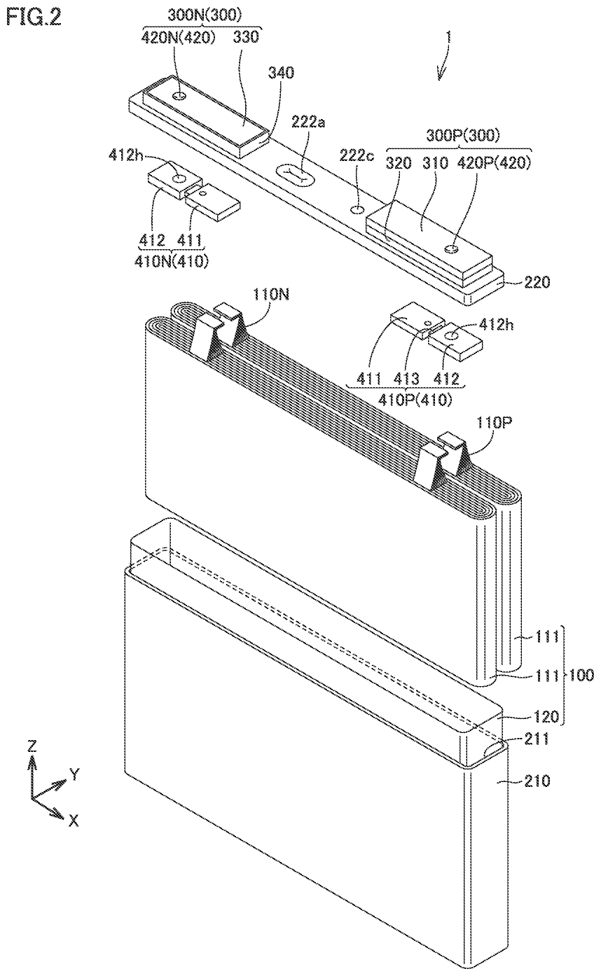

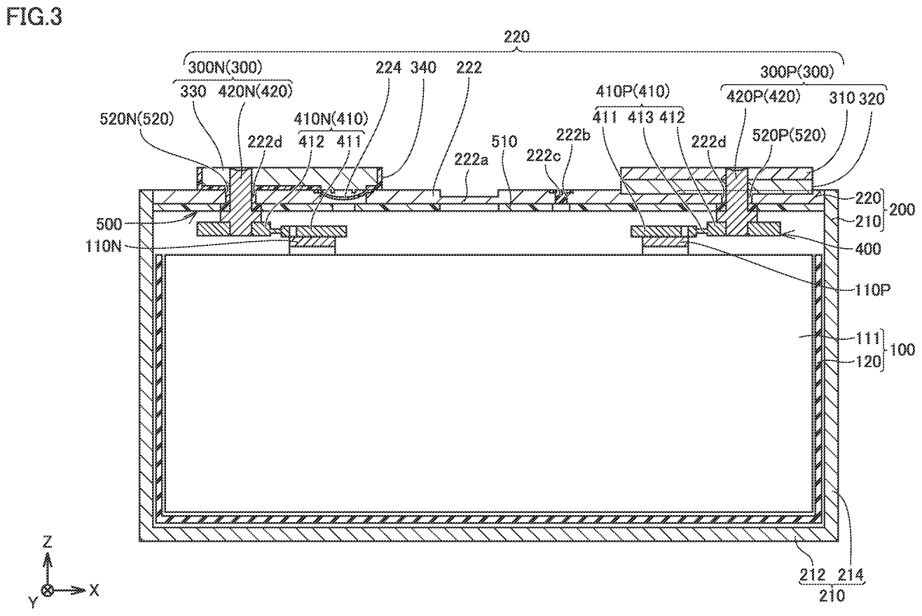

FIG. 1 is a schematic perspective view of a first power storage cell according to the present embodiment. FIG. 2 is an exploded perspective view of the first power storage cell according to the present embodiment. FIG. 3 is a schematic cross-sectional view of the first power storage cell according to the present embodiment. A first power storage cell 1 includes a cell case 200 and an electrode assembly 100.

### 2-1. Electrode Assembly

Electrode assembly 100 may include a plurality of unit electrode assemblies 111 and an insulating film 120, for example (see FIG. 2). Electrode assembly 100 may include two to four unit electrode assemblies 111, for example. Each unit electrode assembly 111 may include a plurality of positive electrode tabs 110P and a plurality of negative electrode tabs 110N. The structures of unit electrode assemblies 111 may be the same as one another, for example. The structures of unit electrode assemblies 111 may be different from each other, for example.

Unit electrode assembly 111 may have any structure. Unit electrode assembly 111 may be a stack-type one, for example. Unit electrode assembly 111 may be a wound-type one, for example. Unit electrode assembly 111 may include a positive electrode sheet, a separator, and a negative electrode sheet, for example. Each of the positive electrode sheet, the negative electrode sheet, and the separator may have a belt-like planar shape, for example.

The positive electrode sheet may include a metal foil and a positive electrode composite material layer, for example. The positive electrode composite material layer may be placed on the surface of the metal foil, for example. The positive electrode composite material layer may be formed by application of a positive electrode slurry to the surface of the metal foil, for example. On the upper long side of the metal foil, an uncoated portion may be formed. At the uncoated portion, the positive electrode composite material layer is not formed. At the uncoated portion, the metal foil is exposed. For instance, to the uncoated portion, the plurality of positive electrode tabs 110P may be bonded. The plurality of positive electrode tabs 110P may be spaced from one another.

The negative electrode sheet may include a metal foil and a negative electrode composite material layer, for example. The negative electrode composite material layer may be placed on the surface of the metal foil, for example. The negative electrode composite material layer may be formed by application of a negative electrode slurry to the surface of the metal foil, for example. At the upper long side of the metal foil, an uncoated portion may be formed. At the uncoated portion, the negative electrode composite material layer is not formed. At the uncoated portion, the metal foil is exposed. For instance, to the uncoated portion, the plurality of negative electrode tabs 110N may be bonded. The plurality of negative electrode tabs 110N may be spaced from one another.

Insulating film 120 may cover both the circumferential surface and the bottom surface of a set of the plurality of unit electrode assemblies 111, for example (see FIG. 2).

### 2-2. Cell Case

Cell case 200 accommodates electrode assembly 100. Cell case 200 also accommodates an electrolyte solution (not illustrated). Cell case 200 is hermetically sealed. Cell case 200 includes a case body 210 and a lid 220.

Case body 210 has an opening 211 that is open upward (see FIG. 2). Case body 210 may be made of metal, for example. Case body 210 may include aluminum (Al) and/or the like, for example. Case body 210 includes a bottom wall 212 and a circumferential wall 214 (see FIG. 3). Bottom wall 212 may have a rectangular flat shape, for example. Circumferential wall 214 rises upward from bottom wall 212. Circumferential wall 214 may have a rectangular tubular shape, for example. The dimension of circumferential wall 214 in the widthwise direction (in the X-axis direction) may be greater than the dimension of circumferential wall 214 in the thickness direction (in the Y-axis direction), for example. The dimension of circumferential wall 214 in the height direction (in the Z-axis direction) may be greater than the dimension of circumferential wall 214 in the thickness direction, for example.

Lid 220 closes opening 211. Lid 220 may be bonded to case body 210 by laser beam welding, for example. Lid 220 may have a flat shape, for example. Lid 220 may be made of metal, for example. Lid 220 may include Al and/or the like, for example. Lid 220 includes a positive electrode terminal 300P, a positive electrode terminal block 320, a lid body 222, an electrically-insulating gasket 520, and a negative electrode terminal 300N (see FIG. 3). That is, cell case 200 includes an electrode terminal 300. Lid body 222 may also be provided with a pressure relief valve 222a, a liquid inlet hole 222b, a sealing member 222c, a pair of through holes 222d, and the like, for example.

### 2-3. Electric Current Path

First power storage cell 1 may include a connecting member 400. Connecting member 400 is electrically conductive. Connecting member 400 includes a current collector plate 410. Current collector plate 410 is connected to a plurality of tabs. Current collector plate 410 includes a positive electrode current collector plate 410P and a negative electrode current collector plate 410N. Positive electrode current collector plate 410P connects the plurality of positive electrode tabs 110P with a positive electrode connecting pin 420P. That is, connecting member 400 electrically connects electrode assembly 100 with electrode terminal 300. Positive electrode current collector plate 410P forms “a first electric current path”.

Positive electrode terminal 300P includes a positive electrode terminal plate 310, positive electrode terminal block 320, and positive electrode connecting pin 420P (see FIG. 3). Positive electrode terminal plate 310 may have an outer shape of a rectangular parallelepiped, for example. Positive electrode terminal plate 310 may be made of metal, for example. Positive electrode terminal plate 310 may include Al and/or the like, for example. Positive electrode terminal block 320 may be made of metal, for example. The material of positive electrode terminal block 320 may be different from that of positive electrode terminal plate 310, for example. The melting point of positive electrode terminal block 320 may be lower than that of positive electrode terminal plate 310. Positive electrode terminal block 320 may include iron (Fe) and/or the like, for example. Positive electrode terminal block 320 is bonded to the upper surface of lid body 222. To the upper surface of positive electrode terminal block 320, positive electrode terminal plate 310 is bonded.

Positive electrode connecting pin 420P may have a cylindrical outer shape, for example. Each of positive electrode terminal plate 310 and positive electrode terminal block 320 is provided with a through hole. Into the through hole, positive electrode connecting pin 420P is inserted. In a state where positive electrode connecting pin 420P is inserted inside a connecting hole 412h, the lower end of positive electrode connecting pin 420P is connected to a second flat-plate portion 412. The upper end of positive electrode connecting pin 420P may be secured to positive electrode terminal plate 310 by swaging, for example.

Negative electrode current collector plate 410N connects the plurality of negative electrode tabs 110N with a negative electrode connecting pin 420N. That is, connecting member 400 electrically connects electrode assembly 100 with negative electrode terminal 300N. Negative electrode current collector plate 410N forms “a second electric current path”.

Negative electrode connecting pin 420N connects negative electrode current collector plate 410N with a negative electrode terminal plate 330. Negative electrode connecting pin 420N may have a cylindrical outer shape, for example. In a state where negative electrode connecting pin 420N is inserted inside connecting hole 412h, the lower end of negative electrode connecting pin 420N is connected to second flat-plate portion 412. The upper end of negative electrode connecting pin 420N may be secured to negative electrode terminal plate 330 by swaging, for example.

### 2-4. Fuse Portion

At least one of the first electric current path and the second electric current path includes a fuse portion. For instance, positive electrode current collector plate 410P may include a fuse portion 413. Positive electrode current collector plate 410P may include a first flat-plate portion 411, fuse portion 413, and second flat-plate portion 412, for example. Fuse portion 413 may be interposed between first flat-plate portion 411 and second flat-plate portion 412. Fuse portion 413 may connect first flat-plate portion 411 with second flat-plate portion 412. Fuse portion 413, first flat-plate portion 411, and second flat-plate portion 412 may be made of the same material, or may be made of different materials.

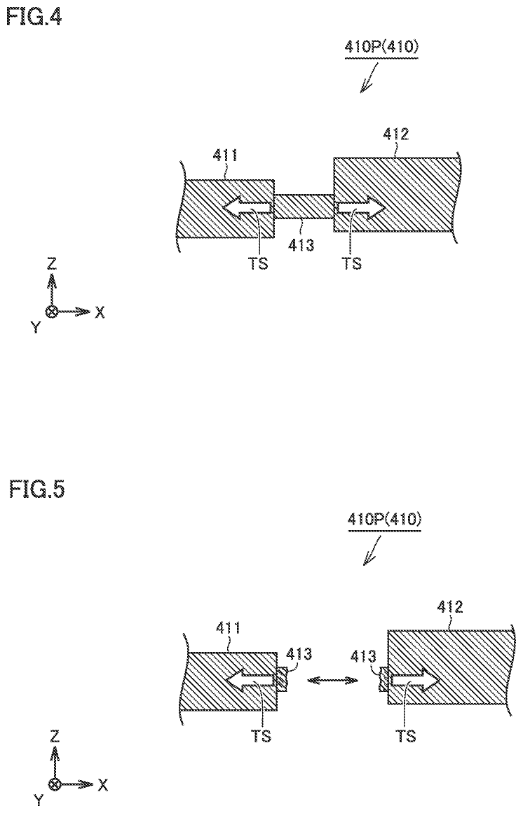

FIG. 4 is a first conceptual view of a fuse portion according to the present embodiment. FIG. 5 is a second conceptual view of the fuse portion according to the present embodiment. Fuse portion 413 includes a fusible material. Fuse portion 413 may consist of a fusible material. Fuse portion 413 may include any fusible material. Fuse portion 413 may include a metal material and/or the like, for example. The cross-sectional area of fuse portion 413 may be smaller than that of first flat-plate portion 411 and that of second flat-plate portion 412, for example. The cross-sectional area herein refers to the area of a cross section that is orthogonal to the current flow direction. In FIG. 4 and FIG. 5, the current flow direction corresponds to the X-axis direction. With the relatively small cross-sectional area, fuse portion 413 may have a greater resistance as compared to other parts. As a result, when an overcurrent flows through positive electrode current collector plate 410P, fuse portion 413 is expected to be blown selectively. The portion with a smaller cross-sectional area may also be called a thin portion.

In the present embodiment, tensile stress TS is applied in a direction separating fuse portion 413. Tensile stress TS may be applied parallel to the current flow direction, for example. The tensile stress may be applied in the X-axis direction, for example. At the time when fuse portion 413 is blown, tensile stress TS is capable of acting to separate the blown tips from each other. Thus, it is expected that reconnection is less likely to occur.

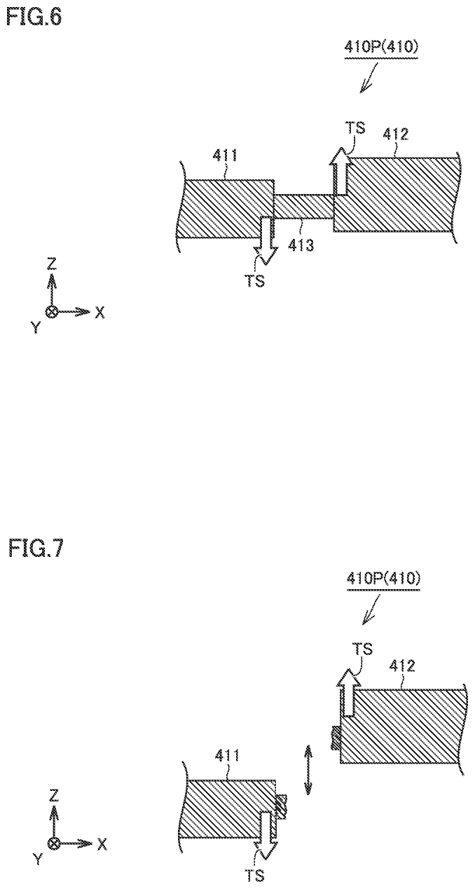

FIG. 6 is a third conceptual view of the fuse portion according to the present embodiment. FIG. 7 is a fourth conceptual view of the fuse portion according to the present embodiment. Tensile stress TS may be applied vertically to the current flow direction, for example. The tensile stress may be applied in the Z-axis direction, for example. The tensile stress may be applied in the Y-axis direction, for example. At the time when fuse portion 413 is blown, tensile stress TS is capable of acting to separate the blown tips from each other. Thus, it is expected that reconnection is less likely to occur.

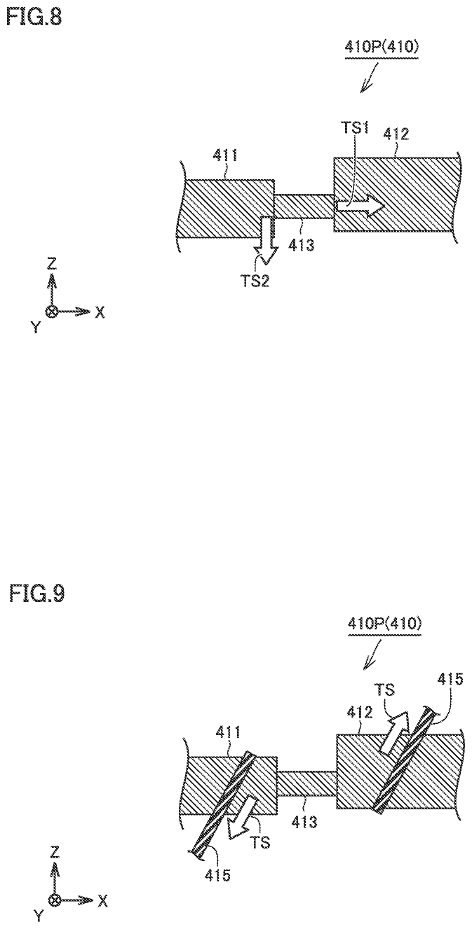

FIG. 8 is a fifth conceptual view of the fuse portion according to the present embodiment. Tensile stress TS may include a plurality of direction components, for example. Tensile stress TS may include a first component TS1 and a second component TS2, for example. First component TS1 may act in the X-axis direction, for example. Second component TS2 may act in the Z-axis direction (the vertical direction), for example. Second component TS2 may act in the Y-axis direction, for example. First component TS1 and second component TS2, in combination, are capable of acting in a direction separating fuse portion 413.

Tensile stress TS may be applied by any structure. For instance, tensile stress TS may be generated by the self-weight of electrode assembly 100. For instance, the self-weight of electrode assembly 100 may act on fuse portion 413 when electrode assembly 100 is not supported by bottom wall 212, circumferential wall 214, insulating film 120, and the like (see FIG. 2, FIG. 3) and electrode assembly 100 is suspended from current collector plate 410 (positive electrode current collector plate 410P and negative electrode current collector plate 410N).

For instance, positive electrode current collector plate 410P may include a welded portion. Tensile stress TS may remain in the welded portion. For instance, the welded portion may be formed between first flat-plate portion 411 and positive electrode tab 110P. For instance, the welded portion may be formed between second flat-plate portion 412 and positive electrode connecting pin 420P.

For instance, welding may be carried out accompanied by flexural deformation. That is, positive electrode current collector plate 410P may include a flexurally-deformed portion. Tensile stress TS may be generated by springback of the flexurally-deformed portion. The flexurally-deformed portion may include a stretching-deformed portion, for example.

FIG. 9 is a sixth conceptual view of the fuse portion according to the present embodiment. For instance, a tensile member 415 may be placed inside cell case 200. For instance, tensile member 415 may include an electrically insulating material, a heat-resistant material, and/or the like. For instance, tensile member 415 may include a resin material and/or the like. For instance, tensile member 415 may be elastic. For instance, tensile member 415 may have a wire-like shape, a coil-spring-like shape, and/or the like. For instance, at least part of tensile member 415 may be secured to the inner surface of cell case 200. For instance, at least part of tensile member 415 may be physically connected to at least one of first flat-plate portion 411 and second flat-plate portion 412. For instance, between tensile member 415 and at least one of first flat-plate portion 411 and second flat-plate portion 412, a heat insulating material may be interposed.

For instance, tensile stress TS may be generated by tensile force of tensile member 415. For instance, tensile stress TS may be generated by springback of tensile member 415. Tensile stress TS may include a component in the X-axis direction, or may include a component in the Y-axis direction, or may include a component in the Z-axis direction. At the time when fuse portion 413 is blown, tensile stress TS may separate first flat-plate portion 411 from second flat-plate portion 412.

For instance, positive electrode current collector plate 410P may include an affected layer. Tensile stress TS may remain in the affected layer. For instance, first flat-plate portion 411 has a first main face. The first main face faces bottom wall 212 (see FIG. 3). Second flat-plate portion 412 has a second main face. The second main face faces lid 220 (see FIG. 3). For instance, each of the first main face and the second main face may be provided with an affected layer. Due to the residual stress in the affected layer, at the time when fuse portion 413 is blown, first flat-plate portion 411 and second flat-plate portion 412 are expected to warp in a direction away from each other. For instance, the affected layer may be formed by laser processing and/or the like.

### 2-5. Other Configurations

First power storage cell 1 may include an insulator 500. Insulator 500 electrically insulates connecting member 400 from cell case 200. Insulator 500 includes an electrically insulating sheet 510 and electrically-insulating gasket 520.

Electrically insulating sheet 510 is connected to the lower surface of lid body 222. Electrically insulating sheet 510 is provided with through holes at a portion overlapping pressure relief valve 222a, a portion overlapping liquid inlet hole 222b, a portion overlapping each through hole 222d, and a portion overlapping an invertible plate 224 (in each case, the portion in question overlaps in the height direction).

Electrically-insulating gasket 520 has a shape surrounding a connecting pin 420. Electrically-insulating gasket 520 electrically insulates connecting pin 420 from cell case 200. Electrically-insulating gasket 520 includes a positive electrode gasket 520P and a negative electrode gasket 520N.

Positive electrode gasket 520P covers positive electrode connecting pin 420P.

Positive electrode gasket 520P has a cylindrical outer shape. Negative electrode gasket 520N covers negative electrode connecting pin 420N. The structure of negative electrode gasket 520N may be the same as that of positive electrode gasket 520P. Negative electrode gasket 520N (an electrically-insulating member) electrically insulates lid body 222 from negative electrode terminal 300N.

Negative electrode terminal 300N includes negative electrode terminal plate 330 and negative electrode connecting pin 420N. Negative electrode terminal plate 330 may be made of metal, for example. Negative electrode terminal plate 330 may include copper (Cu), nickel (Ni), and/or the like, for example. An electrically-insulating member 340 electrically insulates negative electrode terminal 300N from lid body 222. Electrically-insulating member 340 may be made of a resin material, for example. The outer shape of invertible plate 224 may be dish-like, bowl-like, and/or the like, for example. As the internal pressure inside cell case 200 increases, invertible plate 224 may become inverted. Lid body 222 and negative electrode terminal 300N may be configured to become electrically connected with one another when invertible plate 224 is inverted.

### 3. Second Power Storage Cell

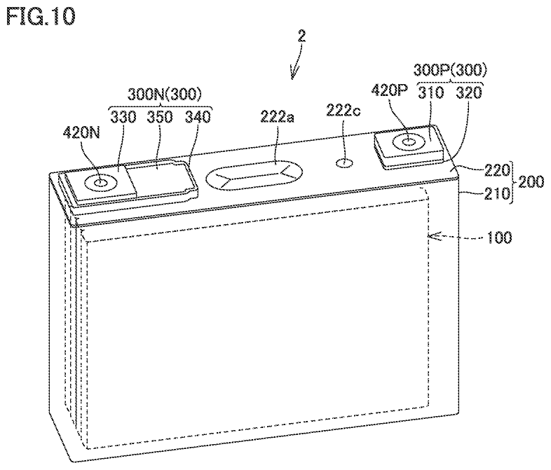

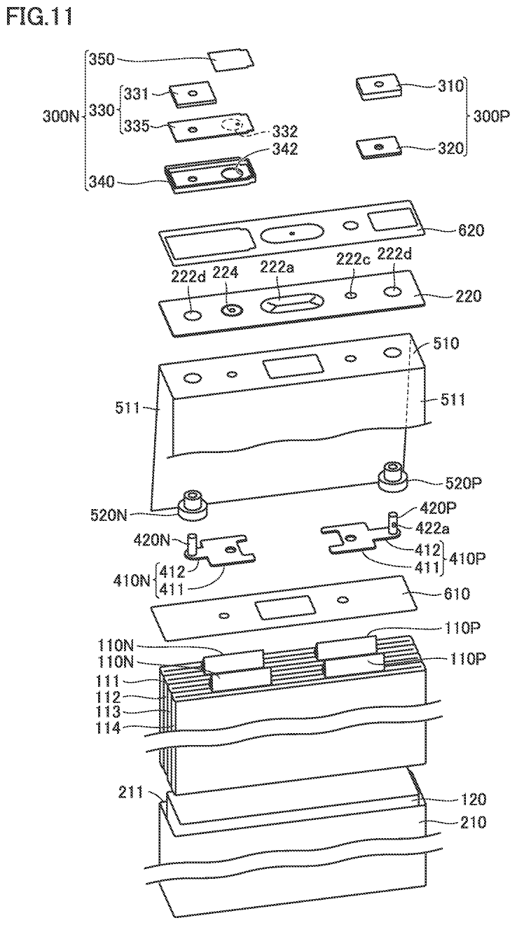

FIG. 10 is a schematic perspective view of a second power storage cell according to the present embodiment. FIG. 11 is an exploded perspective view of the second power storage cell according to the present embodiment. Basically, the below description only explains the differences between a second power storage cell 2 and first power storage cell 1. Explanation of common points between second power storage cell 2 and first power storage cell 1 may be omitted.

Second power storage cell 2 includes an inner electrical insulator 610 and an outer electrical insulator 620. Inner electrical insulator 610 is placed inside cell case 200. More specifically, inner electrical insulator 610 is interposed between electrode assembly 100 and current collector plate 410. Each of positive electrode tab 110P and negative electrode tab 110N is connected to current collector plate 410 at a position above inner electrical insulator 610. Inner electrical insulator 610 is provided with a through hole, at a portion that overlaps the through hole of first flat-plate portion 411 in the height direction. Electrode assembly 100 includes unit electrode assembly 111, a unit electrode assembly 112, a unit electrode assembly 113, and a unit electrode assembly 114 (see FIG. 11).

Outer electrical insulator 620 is placed on the outside of cell case 200. More specifically, outer electrical insulator 620 is placed on the upper surface of lid 220. Outer electrical insulator 620 is provided with through holes, at a portion overlapping positive electrode terminal 300P, a portion overlapping negative electrode terminal 300N, a portion overlapping pressure relief valve 222a, and a portion overlapping liquid inlet hole 222b (in each case, the portion in question overlaps in the height direction).

Insulator 500 further includes a pair of side sheets 511 connected to electrically insulating sheet 510 (see FIG. 11). Each side sheet 511 has a shape that extends downward from a thickness-direction edge of electrically insulating sheet 510. Each side sheet 511 is interposed between a side of electrode assembly 100 and case body 210.

Negative electrode terminal 300N further includes an electrically-insulating plate 350 (see FIG. 10, FIG. 11). Negative electrode terminal plate 330 includes a negative electrode terminal block 331 and an electrically-conductive plate 335. Electrically-conductive plate 335 is secured on electrically-insulating member 340. To electrically-conductive plate 335, negative electrode terminal block 331 is connected. Negative electrode terminal block 331 may be weld to electrically-conductive plate 335. Each of electrically-conductive plate 335 and negative electrode terminal block 331 is provided with a through hole. In the through hole, negative electrode connecting pin 420N is inserted. Electrically-conductive plate 335 includes a facing portion 332. Electrically-insulating plate 350 covers a portion of electrically-conductive plate 335 that is located above invertible plate 224.

Positive electrode current collector plate 410P forms a first electric current path. Negative electrode current collector plate 410N forms a second electric current path. At least one of positive electrode current collector plate 410P and negative electrode current collector plate 410N includes a fuse portion. For instance, positive electrode current collector plate 410P may include a fuse portion (not illustrated in FIG. 11). In the present embodiment, tensile stress (not illustrated in FIG. 11) is applied to the fuse portion. The tensile stress acts in a direction separating the fuse portion.

What is claimed is:

1. A power storage cell comprising:
a cell case; and
an electrode assembly, wherein
the cell case accommodates the electrode assembly,
the cell case includes an electrode terminal,
an electric current path is formed inside the cell case,
the electric current path electrically connects the electrode assembly with the electrode terminal,
the electric current path includes a fuse portion, and
tensile stress is applied to the fuse portion in a direction separating the fuse portion.

2. The power storage cell according to claim 1, wherein the tensile stress is generated by a self-weight of the electrode assembly.

3. The power storage cell according to claim 1, wherein
the electric current path further includes a welded portion, and
the tensile stress remains in the welded portion.

4. The power storage cell according to claim 1, wherein
the electric current path further includes a flexurally-deformed portion, and
the tensile stress is generated by springback of the flexurally-deformed portion.

5. The power storage cell according to claim 1, wherein the tensile stress is
